(19) United States
(12) Patent Application Publication
(10) Pub. No.: US 2008/0034986 A1
(43) Pub. Date: Feb. 14, 2008

(54) Method for Operating a Four-Roll Calendar Machine

(76) Inventors: Bernhard Lucas, Rielasingen- Worblingen (DE); Reiner Riedle, Radolfzell (DE); Uwe Ziegler, Aach (DE); Martin Brutsch, Gailingen (DE)

Correspondence Address: BACHMAN & LAPOINTE, P.C., 900 CHAPEL STREET, SUITE 1201, NEW HAVEN, CT, 06510, US

(21) Appl. No.: 11/631,693

(22) PCT Filed: Feb. 25, 2005
(86) PCT No.: PCT/EP05/02031

§ 371 Date: Feb. 9, 2007

(30) Foreign Application Priority Data
Jul. 8, 2004 (DE) 10 2004 033 235.5

(51) Int. Cl. B29C 43/24; B29C 43/52; B29C 43/58; B30B 3/00

(52) U.S. Cl. 100/35; 100/47

(57) ABSTRACT

A method for operating a four-roll calendar machine (R), according to which a plastic melt from an extrusion nozzle is homogenized first between a first and second roll (W₁, W₂), and then between a third and a fourth roll (W₃, W₄). The position of the third roll (W₃) can be modified in relation to the rolls (W₁) and/or (W₂) even during operation, in order to regulate different operating states.

### BACKGROUND OF THE INVENTION

The present invention relates to a process for operating a four-roll calender in which a plastic melt from an extrusion nozzle is homogenized between a first and a second roll and then between a third and a fourth roll and also to a four-roll calender operating on the basis of the process.

A conventional four-roll calender is known from and described in, for example, DE 195 44 988. Reference is specifically directed to this prior art. This prior art provides the basis for this application.

In the case of conventional four-roll calenders it is disadvantageous that the dwell time of the plastic melt within the four-roll calender is too short.

Since the plastic melt is a good insulator, any transfer of heat away from the plastic melt in the four-roll calender takes place insufficiently quickly with result that the production speed is limited.

In the four-roll calender the plastic melt is reduced to a desired gap width, given surface treatment, cooled and forwarded to receive further treatment, such as, for example, to a roller conveyor.

In that respect it is of further disadvantage that in the case of conventional four-roll calenders these can only be cleaned with difficulty, that in the event of a crash rolls are frequently damaged which is undesirable and, moreover, that it is only possible to change individual rolls of the 4-roll calender by the expenditure of considerable effort and money.

DE 27 43 844 discloses a method for controlling the profile of the last roll-press gap in a calender. Here the last roll and the first roll of the calender can be moved in the vertical direction and the roll lying therebetween can be moved independently in the horizontal direction.

The object of the present invention is to provide a process and also a four-roll calender which eliminate the above-mentioned disadvantages and which increase the production speed, improve the rate at which heat is removed, facilitate an automatic start-up operation and which, in the event of a crash, automatically prevent damage to the rolls.

### SUMMARY OF THE INVENTION

This object is achieved by providing a process for operating a four-roll calender (R) in which a plastic melt (2) from an extrusion nozzle (1) is homogenized between a first and a second roll (W₁, W₂) and then between a third and a fourth roll (W₃, W₄), characterized in that a position of the third roll (W₃) for setting different operating conditions relative to the rolls (W₁ and/or W₂) is changed even during operation. The object is further achieved by providing a four-roll calender for homogenizing a plastic melt (2) with four rolls (W₁, W₂, W₃, W₄), where the plastic melt (2) can be homogenized between the first and second rolls (W₁, W₂) by means of an extrusion nozzle (1), characterized in that even during operation, a position of the third roll (W₃) relative to the rolls (W₁ and/or W₂) can be changed in order to set different operating conditions.

In the case of the present invention it has proven to be particularly advantageous to simultaneously swivel the third and fourth rolls of the 4-roll calendar which are carried in a rotary plate which swivels about an eccentric axis of rotation.

In this situation, the rotary plate allows the fourth roll to be moved relative to the third roll and, independently of the movement of the rotary plate, it permits an adjustment to be made to a gap between the third and fourth rolls.

In particular, the swiveling of the rotary plate permits an adjustment to be made to a gap between a second roll and the third roll while leaving a gap between the third and fourth roll unchanged and constant.

Furthermore and in particular, it has proven to be advantageous in the context of the present invention that as a result of the swiveling of the rotary plate and the consequent swiveling of the third roll which is arranged below the first two rolls a start-up process is simplified in which, for example, the third roll is moved or swiveled, preferably centrally between the two upper rolls. In this way the plastic melt can be brought centrally through the first two rolls onto the third roll in order that manual wrapping of the third roll with the plastic melt can be effected when starting up the production process. This start-up procedure is considerably simplified by this approach.

After the plastic melt has been wrapped around the third roll it is then possible to wrap the plastic melt around the fourth roll by opening the gap between the third and fourth rolls by moving the fourth roll, after which the plastic melt can be transferred to a roller conveyor for further processing.

During this process the plastic melt is uniformly cooled in each of the gaps, as a result of which it receives a desirable surface finish.

By this means it is likewise possible to clean all four rolls during operation since all four rolls are freely accessible.

Furthermore, in relation to the present invention it has proven to be advantageous that all the rolls are of similar construction and can be interchanged between one another. All the rolls have the same diameter, have the same drive, i.e. the same servo and gear units.

Each roll can be exchanged for any another roll. This ensures that only one single roll with a single drive system need be held ready for use as a spare roll to replace either the first, second or third roll if damage is suffered. This also allows a considerable reduction in storage costs to be achieved.

All in all, the present invention provides both a process and a four-roll calender with which it is possible to operate at considerably higher production and/or extrusion speeds. The rate of removal of heat from the plastic melt is also improved and this, too, permits higher throughput and/or production- and extrusion speeds.

### BRIEF DESCRIPTION OF THE DRAWINGS

Further advantages, features and details of the invention are to be found in the following description of preferred exemplary embodiments and with reference to the drawing, in which

FIG. 1 shows a diagrammatic plan view of a four-roll calender for processing a plastic melt delivered by an extrusion nozzle;

FIG. 2 shows a diagrammatic side elevation through the four-roll calender while in operation;

FIG. 3 shows a diagrammatic side elevation as in FIG. 2 but when starting up.

### DETAILED DESCRIPTION

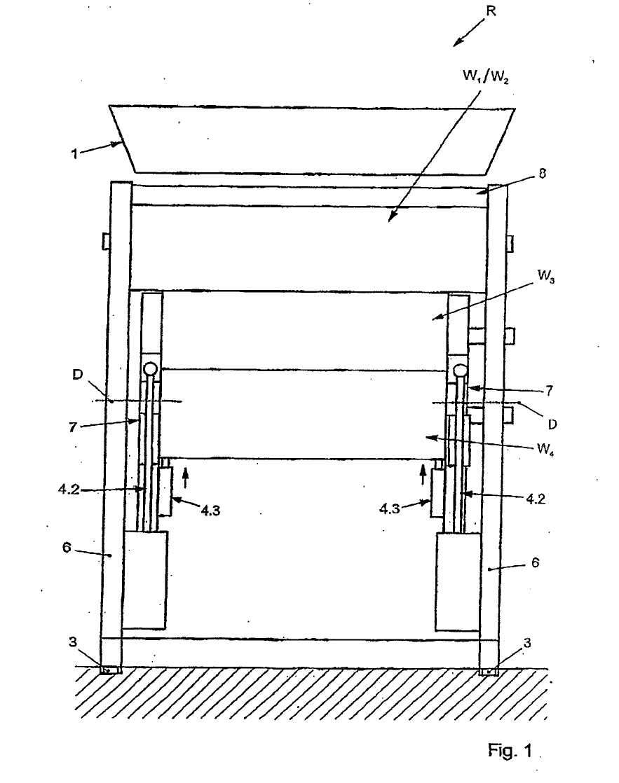

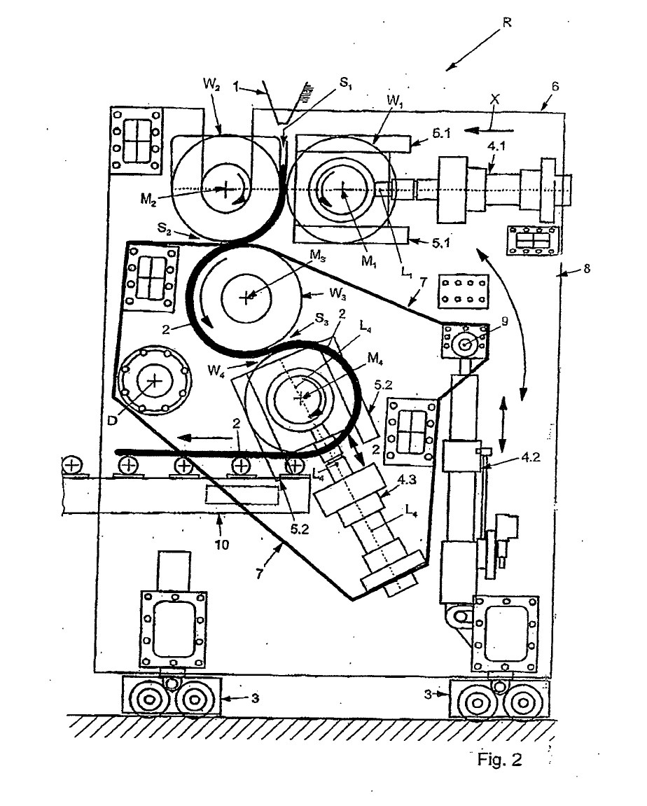

As shown by FIGS. 1 and 2, a plastic melt 2 is fed to a four-roll calender R by means of a broad-slit extrusion nozzle 1 (merely indicated here). In this context the position of the extrusion nozzle 1 is fixed while the four-roll calender R can be moved relative to the background by roll drives 3 indicated here and travel to and fro in the illustrated X-direction.

The essential elements of the four-roll calender R comprise parallel side walls 6 at a distance from one another. The rolls W₁ to W₄ are mounted so as to rotate between the side walls 6 and are actively driven by appropriate drive elements—not shown here in detail—and comprising gear elements and servo-motors.

In addition, the temperature of each roll W₁ to W₄ can be controlled, i.e. heated or cooled.

The rolls W₁ and W₂ are arranged side by side. There, an action line L₂ of a linear drive L₁ or roll W₁ leads through the one central axis M₁ of the roll W₁ and the adjacent roll W₂.

Preferably, the linear guides 5.1 are provided in the side walls 6 and with respect to the roll W₂ guide the roll W₁ movably along the action line L₁ to set and change a gap S₁, even during operation. Each roll W₁ to W₄ is actively driven or capable of being actively driven.

In the case of the present invention it has proven particularly advantageous not to mount the rolls W₃ and W₄ in the side walls 6 but rather within parallel rotary plates 7 at a distance from one another, which as indicated by the direction of the double arrow can be moved to or fro or swiveled about an axis of rotation D by a linear drive 4.2.

The linear drive 4.2 is supported by one side wall 6 or the housing 9 of the four-roll calender R.

Preferably, a point of engagement 9 of the linear drive 4.2 lies far outside the axis of rotation D to facilitate a large lever arm. The rolls W₃ and W₄ are arranged one above the other between the point of engagement 9 and the axis of rotation D and are slightly offset with respect to one another.

The roll W₃ is mounted solely in the rotary plate 7 and in a driven and rotating manner.

The roll W₄ is arranged below the roll W₃, where its central axis M₄ is slightly offset relative to the central axis M₃ of the roll W₃.

By means of linear drive 4.3 the roll W₄ can be moved to and fro in a further linear guide 5.2 provided in the rotary plate 7.

In that respect, the linear guide 5.2 or an action line L₄ is aligned approximately with the central axis M₃ of the roll W₃.

By activating the linear drive 4.3 it is possible to move the roll W₄ towards the roll W₃, so that a gap S₃ can be set and changed in this manner.

In the present invention it is important that independently of the setting of the gap S₃ it is possible to set or adjust the gap S₂ between the rolls W₂ and W₃ by swiveling the rotary plate 7 even during operation.

Consequently there is no coupling between any movement or adjustment of all the gaps S₁, S₂ and S₃, any of which actions can be effected independently even during operation.

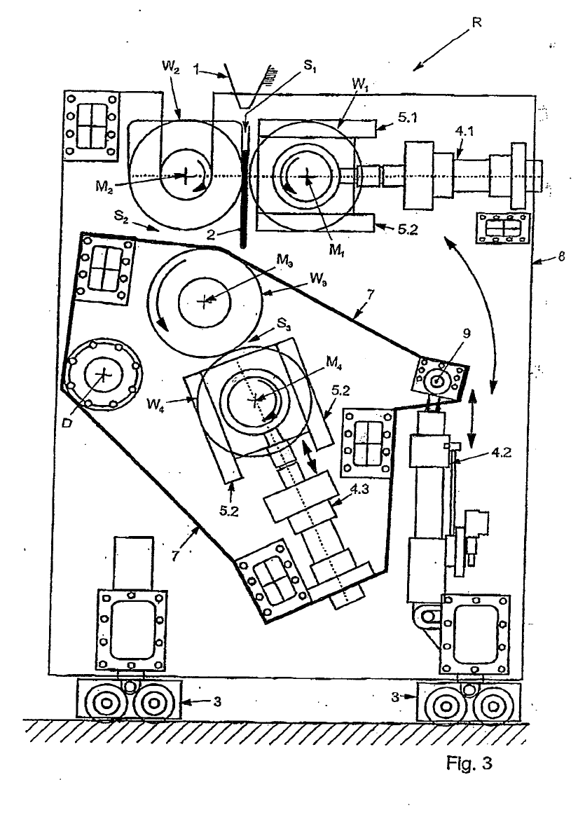

However, it is decisive for the present invention and particularly so for the start-up process as shown, for example, in FIG. 3 that when starting-up, the plastic melt 2 passes directly between the rolls W₁ and W₂ onto the roll W₃ if this is driven about the axis of rotation D by the rotary plate 7 into an approximately central position between the two rolls W₁ and W₂.

Then by appropriate turning of the roll W₃ the plastic melt 2 can be taken up automatically without manual help and wrapped around the roll W₃.

After the melt 3 has been accepted by the roll W₃ it is conceivable that the rotary plate D should sink still further in order to transfer the plastic melt 2 to the roll W₄.

Once the plastic melt 2 has passed between the rolls W₃ and W₄ and wraps round these then, as illustrated in FIG. 2, the plastic melt 2 is then transferred to a roller conveyor 10—which is only indicated here—for further processing.

Even when an emergency shutdown has taken place or during servicing and cleaning operations it is possible by swiveling the rotary plate 7 and hence the rolls W₃ and W₄ easily to carry out cleaning or an exchange of roll drives, etc.

In this context, it is only necessary that the linear drive 4.3 should drive the roll W₄ backwards and thereby enlarge the gap S₃ between roll W₄ and W₃.

By simultaneous swiveling of the rotary plate 7 about the axis of rotation D it is also possible to open the gap S₂ between roll W₂ and roll W₃ in order that here, too, servicing and cleaning work can be undertaken without needing to dismantle the four-roll calender R or to remove individual rolls.

Furthermore, it has proven to be particularly advantageous that each of the linear drives 4.1, 4.2 and 4.3 should be aligned towards the center of the bearing arrangements or the central bearing position of the rolls W₁, W₂ or the center of the bearing of the axis of rotation D to prevent or avoid bending of the rolls W₁ to W₄. This is also intended to come within the framework of the present invention.

Furthermore, it has also proven to be particularly advantageous in the context of the present invention that all the rolls W₁ to W₄ are of similar construction and dimensions and are provided with similar drives, servomotors and/or gear elements.

As a result of this the individual rolls W₁ to W₄ are of universal application or they can be exchanged with one another.

Consequently it is only necessary that for example, only one roll W₁ to W₄ with gear elements, drive elements or the like need be kept ready for use and can serve if required as a replacement for the rolls W₁, W₂, W₃, W₄. In particular, this makes it possible to hold a low-cost stock level of spare parts.

In the four-roll calender the plastic melt is reduced to a desired gap width, given surface treatment, cooled and forwarded to receive further treatment, such as, for example, to a roller conveyor.

In that respect it is of further disadvantage that in the case of conventional four-roll calenders these can only be cleaned with difficulty, that in the event of a crash rolls are frequently damaged which is undesirable and, moreover, that it is only possible to change individual rolls of the 4-roll calender by the expenditure of considerable effort and money.

DE 27 43 844 discloses a method for controlling the profile of the last roll-press gap in a calender. Here the last roll and the first roll of the calender can be moved in the vertical direction and the roll lying therebetween can be moved independently in the horizontal direction.

The object of the present invention is to provide a process and also a four-roll calender which eliminate the above-mentioned disadvantages and which increase the production speed, improve the rate at which heat is removed, facilitate an automatic start-up operation and which, in the event of a crash, automatically prevent damage to the rolls.

This object is achieved by the characteristic features of the patent claims 1 and 16.

In the case of the present invention it has proven to be particularly advantageous to simultaneously swivel the third and fourth rolls of the 4-roll calendar which are carried in

1-28. (canceled)

29. A process for operating a four-roll calender (R) in which a plastic melt (2) from an extrusion nozzle (1) is homogenized between a first and a second roll (W₁, W₂) and subsequently between a third and a fourth roll (W₃, W₄), wherein a position of the third roll (W₃) for setting different operating conditions relative to at least one of the first and second roll, the rolls (W₁ and/or W₂) is changed during the operation and homogenization.

30. The process as claimed in claim 29, wherein, as a starting procedure, the third roll (W₃) is moved to an approximately central position below the first two rolls (W₁ and W₂) in order to transfer the plastic melt (2) to the third roll (W₃).

31. The process as claimed in claim 29, wherein the first roll (W₁) is driven in a controlled manner by a drive in an X-direction with respect to the second roll (W₂) to set a gap (S1).

32. The process as claimed in claim 29, wherein the second roll (W₂) is mounted in a fixed position in a housing (8) in which it can rotate and be driven and that the second roll (W₂) with its drive unit can be removed from a slot in the side walls (6) for the purpose of exchange, maintenance, cleaning or repair.

33. The process as claimed in claim 29, wherein the third roll (W₃) can be actively moved in a controlled manner about an eccentric axis of rotation (D) to change its position relative to that of the roll (W₁) and/or roll (W₂), while the axis of rotation (D) lies outside a central axis (M₃) of the roll (W₃).

34. The process as claimed in claim 33, wherein the roll (W₃) is carried by a rotary plate (7), where the rotary plate (7) is actively driven about the axis of rotation (D) and is swiveled in a controlled manner.

35. The process as claimed in claim 34, wherein the roll (W₄) is arranged beneath the roll (W₃) and can be actively driven relative to the roll (W₃) in a controlled manner during operation.

36. The process as claimed in claim 34, wherein the roll (W₄) is carried by the rotary plate (7) and within the rotary plate (7) can be moved linearly towards the roll (W₃) to change a gap (S₃) between roll (W₃) and roll (W₄) without being coupled to or dependent on the position of the rotary plate (7) or the position of the roll (W₃), it being possible to do so actively in a controlled manner even during operation.

37. The process as claimed in claim 29, wherein temperature of the rolls (W₁ to W₄) can be varied and can all be driven individually, where the drives are integrated in the rolls (W₁ to W₄) or connected to these.

38. The process as claimed in claim 29, wherein all the rolls (W₁ to W₄) are of similar construction and can be interchanged with one another.

39. The process as claimed in claim 34, wherein, even during operation, the rotary plate (7) is swiveled actively in a controlled manner about the axis of rotation (D) by means of a linear drive (4.2), the linear drive (4.2) being supported on one side by a housing (8), by a side wall (6) of the housing (8), and on the other side at the rotary plate (7) it engages with a large lever arm relative to the axis of rotation (D), where the rolls (W₃ and W₄) are mounted in bearings between the point of engagement (9) and the axis of rotation (D).

40. The process as claimed in claim 29, wherein, relative to the roll (W₃), the roll (W₄) can be moved linearly, where an action line (L₄) of the linear drive (4.3) for the roll (W₄) is aligned approximately with a central point (M₃) of the roll (W₃).

41. The process as claimed in claim 29, wherein an action line (L₁) of a linear drive (4.1) for the roll (W₁) is aligned with a central axis (M₂) of the roll (W₂).

42. The process as claimed in claim 34, wherein, by swiveling the rotary plate (7), the roll (W₃) is moved relative to the roll (W₂) and in this way a gap (S₂) is actively changed in a controlled manner.

43. The process as claimed in claim 34, wherein, independently of the movement of the roll (W₃), even during operation, a gap (S₃) can be actively changed in a controlled manner by swiveling the rotary plate (7) about the axis of rotation (D) by moving the roll (W₄) relative to the roll (W₃) by means of a linear drive (4).

44. A four-roll calender for homogenizing a plastic melt (2) comprises first, second, third and fourth rolls (W₁, W₂, W₃, W₄), where the plastic melt (2) is homogenized between the first and second rolls (W₁, W₂) by means of an extrusion nozzle (1), wherein even during operation, means for changing a position of the third roll (W₃) relative to one of the first and second rolls (W₁ and/or W₂) is provided in order to set different operating conditions.

45. The four-roll calender as claimed in claim 44, wherein the first and second rolls (W₁ to W₂) are supported between side walls (6) of a housing (8) where outside the side walls (6) drive elements for each roll (W₁ to W₄) are attached and comprise a motor and/or a gear unit.

46. The four-roll calender as claimed in claim 45, wherein, inside each side wall (6), there is positioned a rotary plate (7) which swivels about an axis of rotation (D) and is mounted in such a manner that it can be swiveled about the axis of rotation (D) by means of at least one linear drive (4.2).

47. The four-roll calender as claimed in claim 46, wherein the position of the third and fourth rolls (W₃ and W₄) between the opposing plates (7) are changed by movement or swiveling about the axis of rotation (D), being driven by the linear drive (4.2).

48. The four-roll calender as claimed in claim 46, wherein, even during operation, the fourth roll (W₄) is driven by a further linear drive (4.3) towards the third roll (W₃) to actively set a gap (S₃).

49. The four-roll calender as claimed in claim 46, wherein, even during operation, the fourth roll (W₄) is moved and driven by the at least one linear drive (4.3) towards the third roll (W₃) in a linear manner in a linear guide (5) integrated in the rotary plate (7).

50. The four-roll calender as claimed in claim 48, wherein, to set a gap (S₂) between the second roll (W₂) and the third roll (W₃), the rotary plate (7) is moved about the axis of rotation (D) by the linear drive (4.2) and the gap (S₃) between the third and fourth rolls (W₃ and W₄) remains constant and is changed by the movement of the fourth roll (W₄) relative to the third roll (W₂) by the further linear drive (4.3).

51. The four-roll calender as claimed in claim 46, wherein an action line (L₄) of the further linear drive (4.3) of the fourth roll (W₄) is aligned with the central axis (M₃) of the third roll (W₃).

52. The four-roll calender as claimed in claim 46, wherein an action line (L₁) of a linear drive (4.1) for the roll first (W₁) is aligned with a central axis (M₂) of the second roll (W₂).

53. The four-roll calender as claimed in claim 50, wherein a change in the gap (S₂) between the second roll (W₂) and the third roll (W₃) is effected by activation of the linear drive (4.2), and by swiveling the rotary plate (7) about the axis of rotation (D), this being independent of a setting of the gap (S₃) between the third roll (W₃) and the fourth roll (W₄) or independently of a setting of the gap (S₁) between the second roll (W₂) and the first roll (W₁).

54. The four-roll calender as claimed in claim 53, wherein, by swiveling the rotary plate (7) about the axis of rotation (D) by means of the linear drive (4.2) to effect a drive-up position, the third roll (W₃) can be driven to an approximately central position between the first and second rolls (W₁ and W₂) in order to accept the plastic melt (2).

55. The four-roll calender as claimed in claim 44, wherein all the rolls (W₁ to W₄) and appropriate drives and connected gear elements are of similar construction and are interchangeable between one another.

56. The four-roll calender as claimed in claim 45, wherein a slot-like aperture is formed in side walls (6) of the housing (8) to receive and mount the second roll (W₂).
